(19) United States
(12) Patent Application Publication
(10) Pub. No.: US 2015/0084913 A1
(43) Pub. Date: Mar. 26, 2015

(54) INFORMATION PROCESSING METHOD FOR TOUCH PANEL DEVICE AND TOUCH PANEL DEVICE

(71) Applicant: Akihiro Okano, Kawasaki-shi (JP)

(72) Inventor: Akihiro Okano, Kawasaki-shi (JP)

(73) Assignees: PIONEER SOLUTIONS CORPORATION, Kawasaki-shi (JP); PIONEER CORPORATION, Kawasaki-shi (JP)

(21) Appl. No.: 14/358,479

(22) PCT Filed: Nov. 22, 2011
(86) PCT No.: PCT/JP2011/076950

§ 371 Date: May 15, 2014

(51) Int. Cl. G06F 3/044; G06F 3/046

(52) U.S. Cl. CPC G06F 3/044; G06F 3/046; G06F 2203/04104
USPC 345/174

(57) ABSTRACT

A touch panel device includes: a display having a display surface disposed to face upward; an image-displaying unit being configured to display an object image on the display surface; a pointed position detector being configured to detect pointed positions that are positions where three or more fingers are brought into contact or almost into contact with the display surface; an image identifier being configured to identify the object image that is displayed at the pointed positions; an estimating unit being configured to estimate a position where an operator, who has the fingers, is present based on a position relationship of the pointed positions of the three or more fingers; and a display changer being configured to change a display state of the object image such that the object image is set in a predetermined orientation in accordance with the estimated position of the operator.

### TECHNICAL FIELD

The present invention relates to an information processing method for a touch panel device, and a touch panel device.

### BACKGROUND ART

There has been conventionally known a touch panel device that performs processing in accordance with a contact or almost-contact position in a display surface of the touch panel device. Such a touch panel device is capable of switching an image on the display surface to perform various types of processing and thus is used in a variety of applications. In the touch panel device, the orientation, position and size of an object image can be changed in accordance with the contact state of a finger on the display surface.

Various ways are considered to improve the operability of the above touch panel device (see, for instance, Patent Literature 1).

Patent Literature 1 discloses that when a button is touched with a plurality of fingers, a variety of processing is performed in accordance with a distance between the fingers or a transient change in the distance.

### CITATION LIST

### Patent Literature(s)

Patent Literature 1: JP-A-2001-228971

### SUMMARY OF THE INVENTION

### Problem(s) to be Solved by the Invention

The above arrangement of Patent Literature 1, however, requires displaying an operation button in addition to an object image, so that the processing of the touch panel device may become complicated.

An object of the invention is to provide an information processing method for a touch panel device with a simple arrangement to easily change a display state of an object image displayed on a display surface, and a touch panel device.

### Means for Solving the Problem(s)

According to an aspect of the invention, an information processing method for a touch panel device that performs a process in accordance with a position of a pointer brought into contact or almost into contact with a display surface of the touch panel device that is disposed to face upward, the method includes: displaying an object image on the display surface; detecting, when an operator brings the pointer including three or more pointers into contact or almost into contact with the display surface, respective pointed positions corresponding to the three or more pointers; identifying the object image that is displayed in at least part of an area surrounded by the pointed positions of the three or more pointers; estimating a position where the operator, who has the three or more pointers, is present based on a position relationship of the pointed positions of the three or more pointers; and changing a display state of the identified object image such that the identified object image is set in a predetermined orientation in accordance with the estimated position of the operator.

According to another aspect of the invention, a touch panel device that performs a process in accordance with a position of a pointer brought into contact or almost into contact with a display surface of the touch panel device includes: a display having the display surface disposed to face upward; an image-displaying unit being configured to display an object image on the display surface; a pointed position detector being configured to detect, when an operator brings the pointer including three or more pointers into contact or almost into contact with the display surface, respective pointed positions corresponding to the three or more pointers; an image identifier being configured to identify the object image that is displayed in at least part of an area surrounded by the pointed positions of the three or more pointers; an estimating unit being configured to estimate a position where the operator, who has the three or more pointers, is present based on a position relationship of the pointed positions of the three or more pointers; and a display changer being configured to change a display state of the identified object image such that the identified object image is set in a predetermined orientation in accordance with the estimated position of the operator.

### BRIEF DESCRIPTION OF DRAWING(S)

FIG. 1 is a perspective view showing a touch panel device according to first and second exemplary embodiments of the invention.

FIG. 2 schematically shows an arrangement of an infrared emitting/receiving unit of the touch panel device.

FIG. 3 is a block diagram schematically showing an arrangement of the touch panel device.

FIG. 4 is a flow chart showing a display-changing process according to the first and second exemplary embodiments.

FIG. 5 is a flow chart showing the display-changing process according to the first exemplary embodiment.

FIG. 6 schematically shows a display state before the display-changing process is performed when an operator is present near a front portion according to the first exemplary embodiment.

FIG. 7 schematically shows a display state before the display-changing process is performed when an operator is present near a rear portion according to the first exemplary embodiment.

FIG. 8 schematically shows a display state after the display-changing process is performed when an operator is present near the front portion according to the first and second exemplary embodiments.

FIG. 9 schematically shows a display state after the display-changing process is performed when an operator is present near the rear portion according to the first exemplary embodiment.

FIG. 10 is a flow chart showing the display-changing process according to the second exemplary embodiment.

FIG. 11 schematically shows a display state before the display-changing process is performed when an operator is present near the front portion according to the second exemplary embodiment.

FIG. 12 is a perspective view of a touch panel device according to a modification of the invention.

FIG. 13 is a block diagram schematically showing an arrangement of the touch panel device according to the modification.

### DESCRIPTION OF EMBODIMENT(S)

### First Exemplary Embodiment

The first exemplary embodiment of the invention will be first described with reference to the attached drawings.

### Arrangement of Touch Panel Device

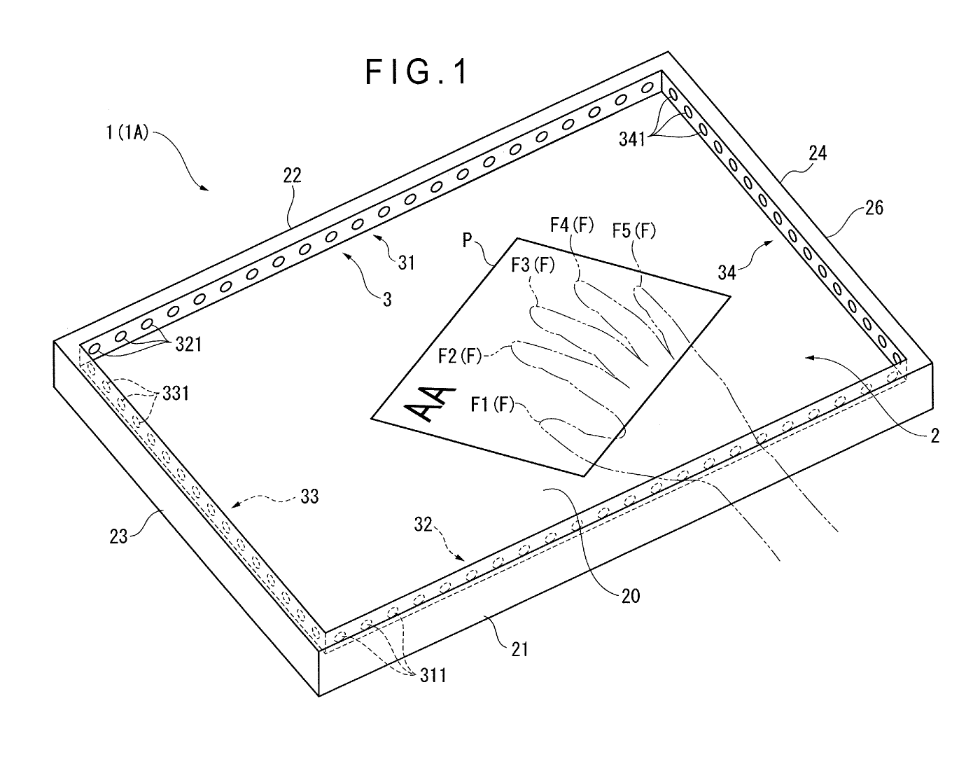

As shown in FIG. 1, a touch panel device 1 is formed in the shape of a table and has a display surface 20 disposed to face upward. When fingers F of a person (i.e., a pointer), which include a thumb F1, an index finger F2, a middle finger F3, a third finger F4 and little finger F5, are in contact or almost in contact with the display surface 20 (a state where the fingers F are in contact or almost in contact with display surface 20 is hereinafter occasionally expressed as “pointed on/above the display surface 20”), the touch panel device 1 performs processing in accordance with the contact or almost-contact position (the contact or almost-contact position is hereinafter occasionally expressed as “pointed position”).

As shown in FIGS. 1 to 3, the touch panel device 1 includes a display 2, an infrared emitting/receiving unit 3 and a controller 4.

The display 2 includes the display surface 20 in a rectangular shape. The display 2 is received in a rectangular frame 26 with the display surface 20 facing upward. The frame 26 includes a front portion 21 that is one of the long sides of the rectangular shape, a rear portion 22 that is the other long side of the rectangular shape, a left portion 23 that is one of the short sides of the rectangular shape, and a right portion 24 that is the other short side of the rectangular shape.

The infrared emitting/receiving unit 3 includes a first emitter 31 provided to the front portion 21 of the frame 26, a first light-receiver 32 provided to the rear portion 22, a second emitter 33 provided to the left portion 23, and a second light-receiver 34 provided to the right portion 24.

The first emitter 31 and the second emitter 33 include a plurality of first emitting elements 311 and a plurality of second emitting elements 331, respectively. The first emitting elements 311 and the second emitting elements 331 are provided by infrared LEDs (Light-Emitting Diodes) capable of emitting an infrared ray L.

The first light-receiver 32 and the second light-receiver 34 include as many first light-receiving elements 321 and the second light-receiving elements 341 as the first emitting elements 311 and the second emitting elements 331, respectively. The first light-receiving elements 321 and the second light-receiving elements 341 are provided by infrared-receiving elements capable of receiving the infrared ray L and are located on the optical axes of the first emitting elements 311 and the second emitting elements 331, respectively.

The first emitting elements 311 and the second emitting elements 331 emit the infrared ray L in parallel with the display surface 20 under the control of the controller 4. Upon reception of the infrared ray L, the first light-receiving elements 321 and the second light-receiving elements 341 each output a light-receiving signal corresponding to the amount of the received infrared ray L to the controller 4.

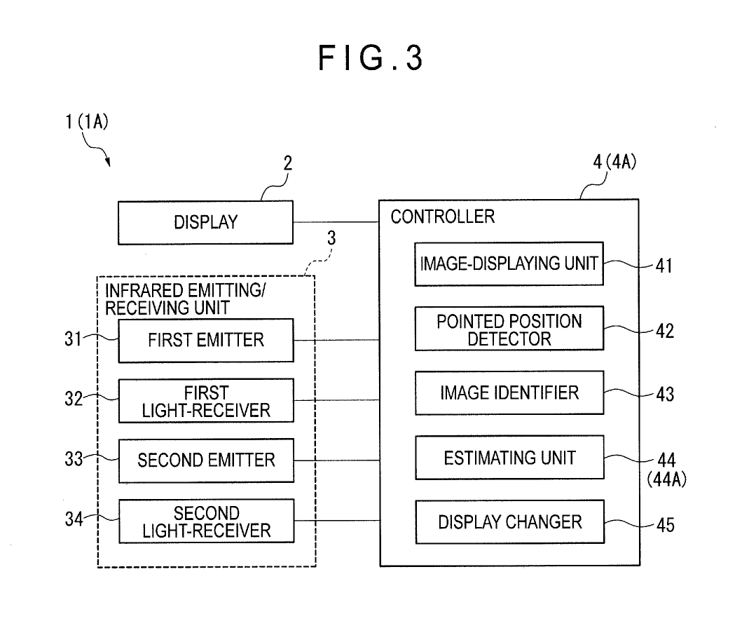

As shown in FIG. 3, the controller 4 includes an image-displaying unit 41, a pointed position detector 42, an image identifier 43, an estimating unit 44 and a display changer 45, which are provided by processing program and data stored in a memory (not shown) with a CPU (Central Processing Unit).

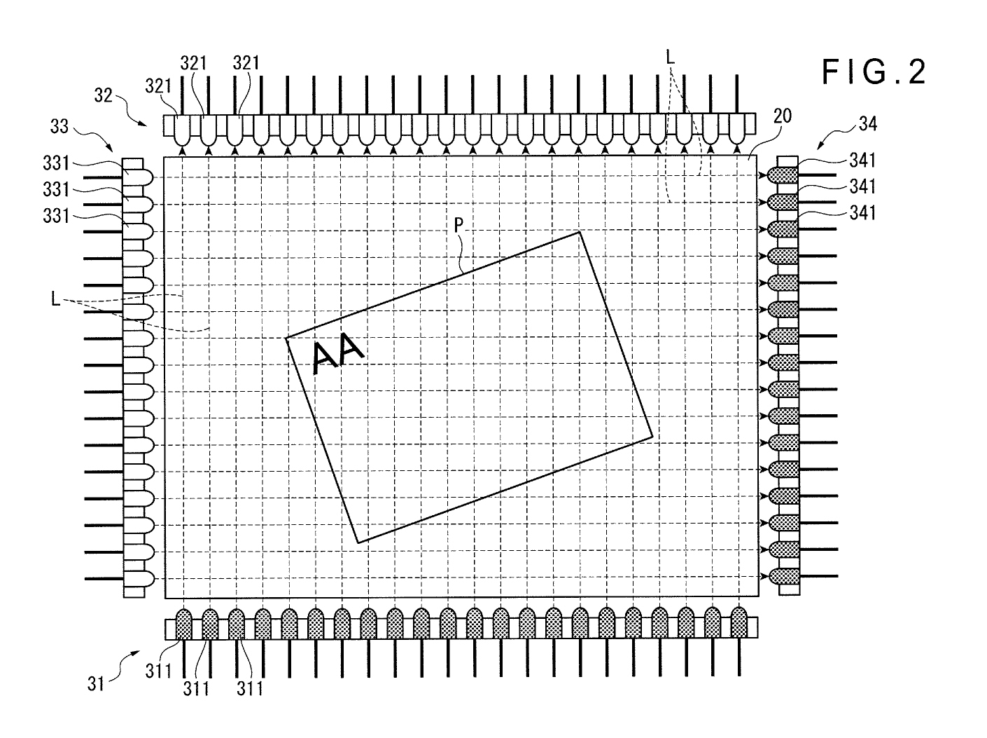

The image-displaying unit 41 displays various images on the display surface 20 of the display 2. For instance, an object image P is displayed as shown in FIGS. 1 and 2.

In the exemplary embodiment, examples of the object image P are: documents, tables and graphs made by various types of software; images of landscapes and people captured by an imaging unit; and image contents such as animation and movies.

The pointed position detector 42 performs scanning on the display surface 20 with the infrared ray L from the first emitting elements 311 and the second emitting elements 331, and determines that a predetermined position on the display surface 20 is pointed by the fingers F upon detection of interception of the infrared ray L. Further, the pointed position detector 42 detects the number of the fingers F based on the number of light-intercepted positions.

The image identifier 43 identifies, from among the object image(s) P displayed on the display surface 20, one displayed in an area overlapping with the pointed positions of the fingers F detected by the pointed position detector 42.

Based on a position relationship of the pointed positions of at least three of the fingers F detected by the pointed position detector 42, the estimating unit 44 estimates a position where an operator, who has the fingers F, is present.

The display changer 45 changes a display state of the object image P identified by the image identifier 43 such that the object image P is set in a predetermined orientation in accordance with the position of the operator estimated by the estimating unit 44.

Operation of Touch Panel Device

Next, an operation of the touch panel device 1 will be explained. Incidentally, although the operation described herein is performed, for instance, when the five fingers F (the thumb F1, the index finger F2, the middle finger F3, the third finger F4 and the little finger F5) are brought into contact with the display surface 20, the same operation is performed even when the fingers F are brought almost into contact.

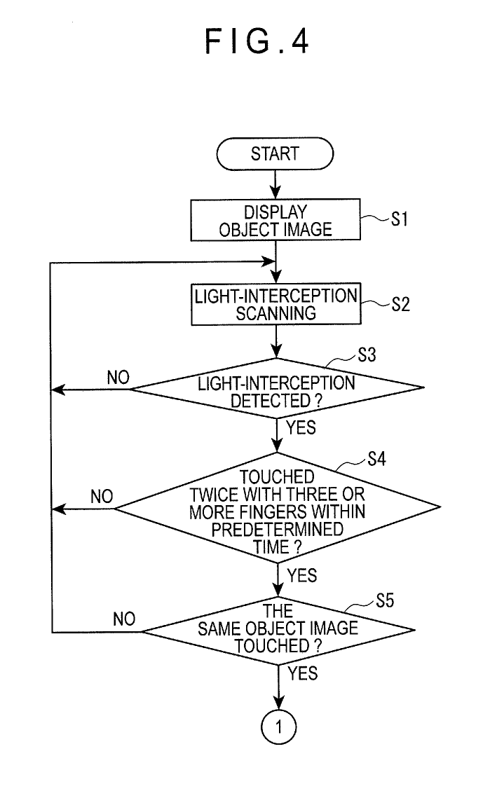

As shown in FIG. 4, upon detection that, for instance, the touch panel device 1 is switched on and a predetermined operation is performed, the image-displaying unit 41 of the controller 4 of the touch panel device 1 displays the object image P as shown in FIG. 1 on the display surface 20 (step S1).

When an operator of the touch panel device 1 wishes to change the orientation of the object image P, he/she touches a display area of the object image P in the display surface 20 with the fingers F.

Subsequently, the pointed position detector 42 performs light-interception scanning with the infrared ray L to determine whether or not the display surface 20 is touched with the fingers F (step S2). The pointed position detector 42 then determines whether or not interception of the infrared ray L is detected (step S3). The processes in step S2 and step S3 are repeated until interception of the infrared ray L is detected.

Specifically, during repetition of step S2 and step S3, the pointed position detector 42 activates the first emitting elements 311 one by one to emit the infrared ray L in a sequential manner from the leftmost one in FIG. 2. Similarly, the pointed position detector 42 activates the second emitting elements 331 one by one to emit the infrared ray L in a sequentially manner from the uppermost one in FIG. 2. The pointed position detector 42 then determines whether or not light interception is detected based on light-receiving signals from the first light-receiving elements 321 and the second light-receiving elements 341 that are correspondingly opposed to the first emitting elements 311 and the second emitting elements 331.

When light interception is detected in step S3, the pointed position detector 42 determines whether or not the display surface 20 is touched twice with three or more of the fingers F within a predetermined duration of time (e.g., one second) (step S4). In other words, it is determined whether or not the display surface 20 is intermittently touched twice with the fingers F within the predetermined duration of time. Incidentally, it may be determined whether or not the display surface 20 is intermittently touched three or more times with the fingers F.

When the pointed position detector 42 determines that the display surface 20 is not intermittently touched twice with the fingers F within the predetermined duration of time in step S4, the process returns to step S2 after a predetermined process is performed as needed.

In contrast, upon determination that the display surface 20 is intermittently touched twice (double-tapped) with the three or more fingers F within the predetermined duration of time in step S4, the pointed position detector 42 detects the pointed positions of the three or more fingers F. The image identifier 43 determines whether or not the same object image P is touched successively twice based on the pointed positions (step S5). Specifically, the image identifier 43 identifies the object image P touched with the three or more fingers F. When the same object image P is not touched with all the three or more fingers F (e.g., while one of the fingers F is in touch with the object image P, the other two or more fingers F are in touch with a portion different from this object image P) in step S5, the process returns to step S2.

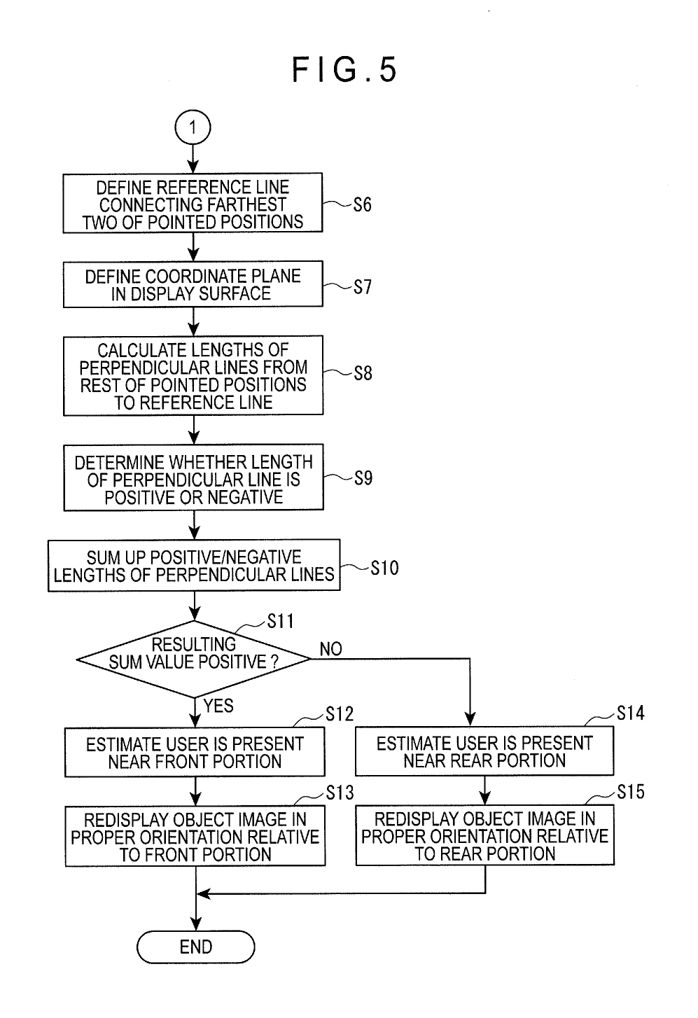

When the image identifier 43 determines that the same object image P is touched with the three or more fingers F in step S5, the estimating unit 44 defines a reference line linearly connecting the farthest two of the pointed positions of the three or more fingers F as shown in FIG. 5 (step S6).

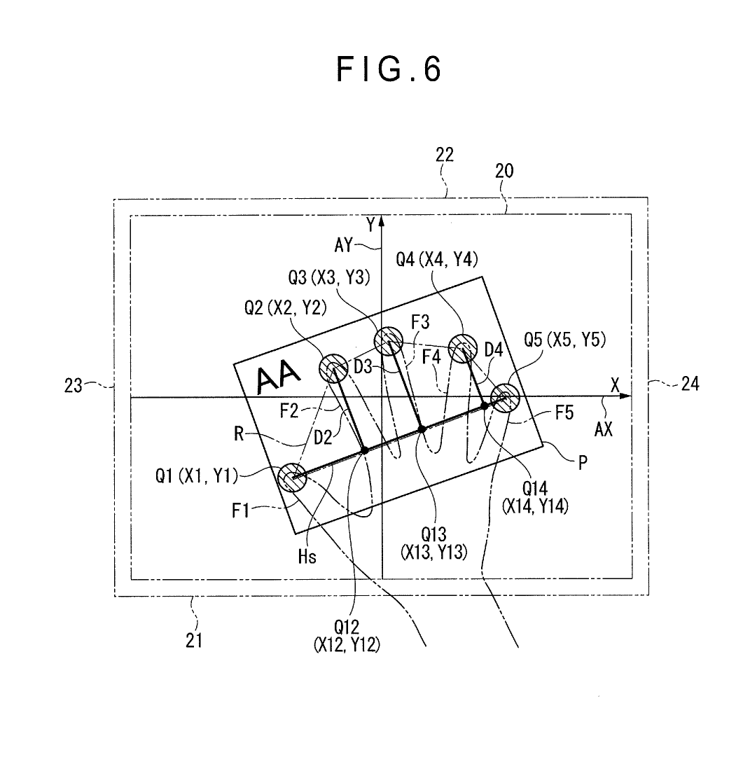

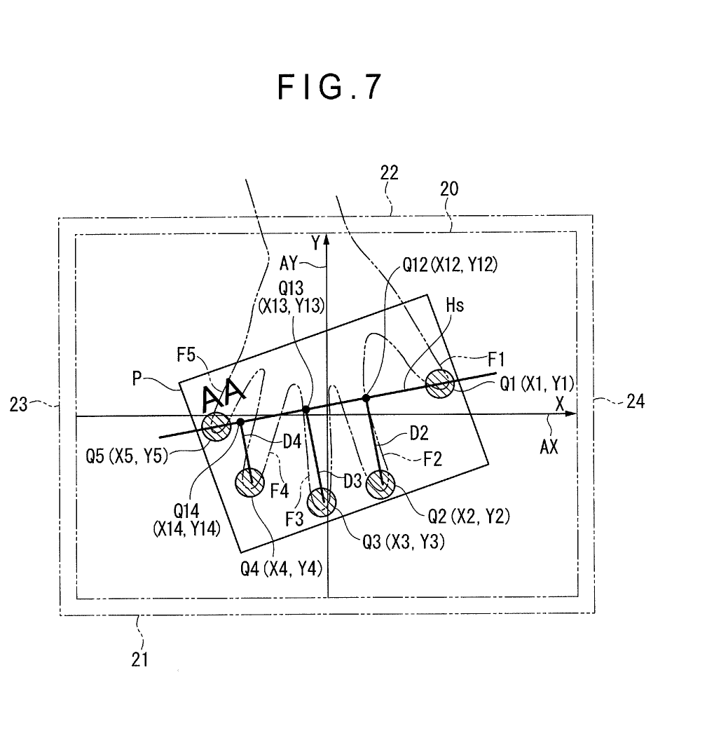

Specifically, when the five fingers F1 to F5 are in touch with the object image P as shown in FIGS. 6 and 7, the estimating unit 44 detects pointed positions Q1, Q2, Q3, Q4, Q5 of the thumb F1, the index finger F2, the middle finger F3, the third finger F4 and the little finger F5. The estimating unit 44 then determines that the pointed position Q1 of the thumb F1 and the pointed position Q5 of the little finger F5 are the farthest from each other and thus defines a reference line Hs connecting the pointed position Q1 and the pointed position Q5.

Next, the estimating unit 44 defines a two-dimensional coordinate plane having an X-axis AX (a first coordinate axis) and a Y-axis AY (a second coordinate axis) on the display surface 20 (step S7). Subsequently, the estimating unit 44 defines perpendicular lines from the rest of the pointed positions to the reference line Hs and calculates lengths of the perpendicular lines (step 8).

Specifically, as shown in FIGS. 6 and 7, the estimating unit 44 defines perpendicular lines D2, D3, D4 from the pointed position Q2 of the index finger F2, the pointed position Q3 of the middle finger F3 and the pointed position Q4 of the third finger F4 to the reference line Hs. Further, the estimating unit 44 determines that coordinates of the pointed position Q2 of the index finger F2, the pointed position Q3 of the middle finger F3 and the pointed position Q4 of the third finger F4 are respectively (X2, Y2), (X3, Y3) and (X4, Y4) based on the coordinate plane. The estimating unit 44 then calculates the lengths of the perpendicular lines D2, D3, D4.

Subsequently, the estimating unit 44 determines whether each of the lengths of the perpendicular lines is positive or negative (step S9). Specifically, when the pointed position Q2, which is located at a first end of the perpendicular line D2, is larger in Y-coordinate (second coordinate) value than an intersection Q12 of the perpendicular line D2 with the reference line Hs, which is located at a second end of the perpendicular line D2, as shown in FIGS. 6 and 7, the estimating unit 44 determines that the length of the perpendicular line D2 is a positive value, and when the pointed position Q2 located at the first end is smaller, the estimating unit 44 determines that the length of the perpendicular line D2 is a negative value.

In the case as shown in FIG. 6, the pointed positions Q2, Q3, Q4 are respectively larger in Y-coordinate value than the intersections Q12, Q13, Q14 on the reference line Hs, so that the estimating unit 44 determines that the lengths of the perpendicular lines D2, D3, D4 are positive values.

In the case as shown in FIG. 7, the pointed positions Q2, Q3, Q4 are respectively smaller in Y-coordinate value than the intersections Q12, Q13, Q14 on the reference line Hs, so that the estimating unit 44 determines the lengths of the perpendicular lines D2, D3, D4 are negative values.

The estimating unit 44 then sums up the positive or negative lengths of the perpendicular lines (step S10) and determines whether or not the resulting sum value is a positive value (step S11).

Upon determination that the resulting sum value is positive in step S11, the estimating unit 44 estimates that the operator is present near the front portion 21 relative to the display surface 20 (step S12). Subsequently, the display changer 45 redisplays the object image P in a proper orientation relative to the front portion 21 (step S13), and then the process is completed.

Incidentally, “redisplays the object image P in a proper orientation relative to the front portion 21” means that, for instance, when the object image P is intended to properly show a character or a building included therein to an operator who is present near the front portion 21, the object image P is redisplayed with a lower side of the character or the building being positioned near the front portion 21 and an upper side of the character or the building being positioned near the rear portion 22.

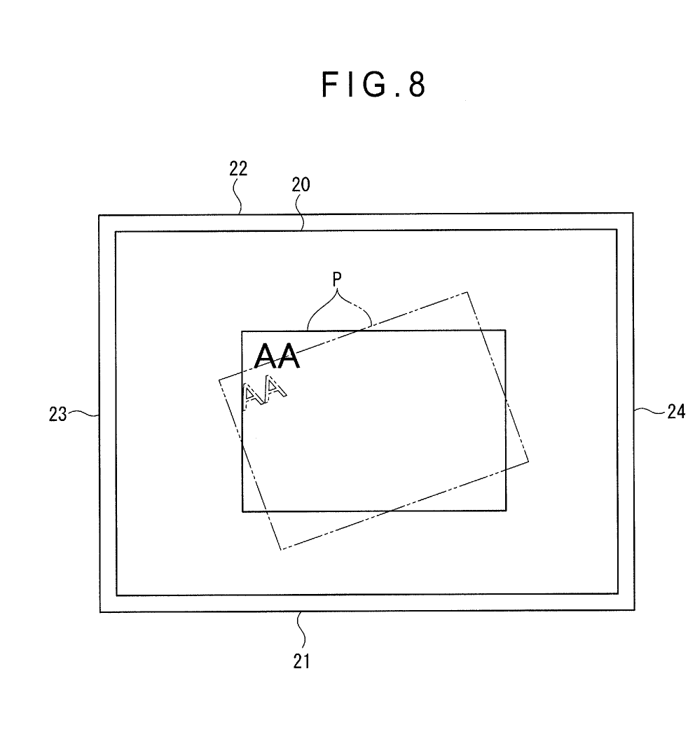

Specifically, in the case as shown in FIG. 6, the controller 4 estimates that the operator is present near the front portion 21 in step S12 and redisplays the object image P with characters “AA” in the object image P being properly viewed from the front portion 21 as shown in FIG. 8 in step S13.

In contrast, upon determination that the resulting sum value is negative in step S11, the estimating unit 44 estimates that the operator is present near the rear portion 22 relative to the display surface 20 (step S14). Subsequently, the display changer 45 redisplays the object image P in a proper orientation relative to the rear portion 22 (step S15), and then the process is completed.

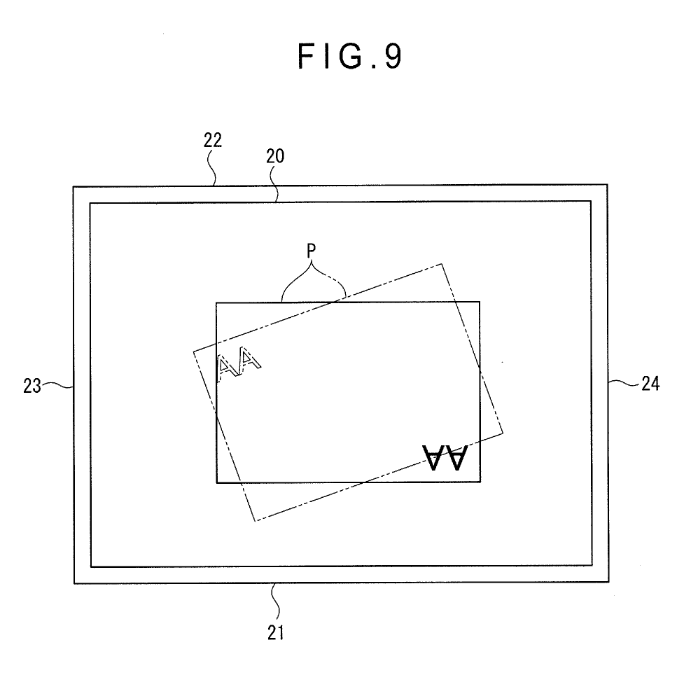

Specifically, in the case as shown in FIG. 7, the controller 4 estimates that the operator is present near the rear portion 22 in step S13 and redisplays the object image P with characters “AA” in the object image P being properly viewed from the rear portion 22 as shown in FIG. 9 in step S14.

### Effects of First Exemplary Embodiment

The above first exemplary embodiment provides the following effects (1) and (2).

(1) Upon determination that the object image P is pointed with three or more of the fingers F, the touch panel device 1 estimates the position of an operator based on a position relationship of the three or more fingers. The touch panel device 1 changes the display state of the object image P such that the object image P is set in a proper orientation relative to the position where the operator is present.

With this arrangement, the touch panel device 1 can redisplay the object image P in the proper orientation even when no button for changing the display state of the object image P is displayed.

(2) The touch panel device 1 defines the reference line Hs linearly connecting the pointed positions of the thumb F1 and the little finger F5 (i.e., the pointed positions of the farthest two of the pointed positions of the fingers F) as well as the two-dimensional coordinate plane. Further, the touch panel device 1 calculates the lengths of the perpendicular lines D2, D3, D4 from the pointed positions of the index finger F2, the middle finger F3 and the third finger F4 to the reference line Hs. Subsequently, the touch panel device 1: determines whether the lengths of the perpendicular lines D2, D3, D4 are each positive or negative based on the coordinates in the coordinate plane; sums up the lengths of the perpendicular lines D2, D3, D4; and estimates that an operator is present on a negative direction side with reference to the Y-axis AY (i.e., near the front portion 21) when the sum value is positive or estimates that the operator is present on a positive direction side with reference to the Y-axis AY (i.e., near the rear portion 22) when the sum value is negative.

With this arrangement, the touch panel device 1 can estimate the position where the operator is present in such a simple manner as calculation based on the coordinates of the pointed positions specified in the coordinate plane.

### Second Exemplary Embodiment

Next, a second exemplary embodiment of the invention will be described with reference to the attached drawings.

### Arrangement of Touch Panel Device

As shown in FIGS. 1 and 3, a touch panel device 1A according to the second exemplary embodiment is different from the touch panel device 1 according to the first exemplary embodiment in a process performed by an estimating unit 44A of a controller 4A.

Operation of Touch Panel Device

Next, an operation of the touch panel device 1A will be explained.

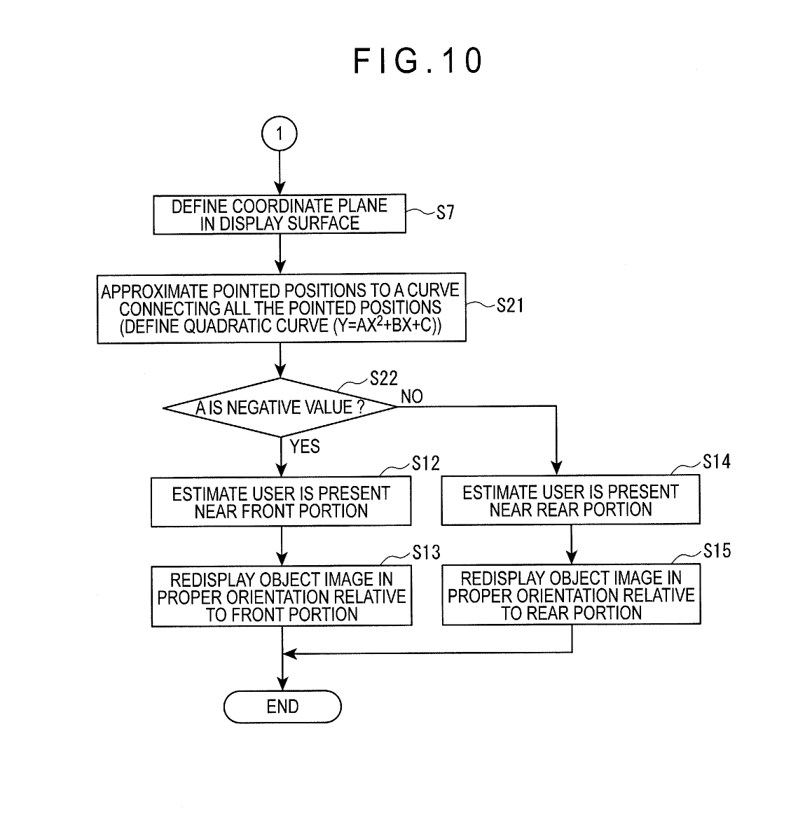

After performing the processes of steps S1 to S5 as shown in FIG. 4, the controller 4A of the touch panel device 1A performs the process of step S7 as shown in FIG. 10.

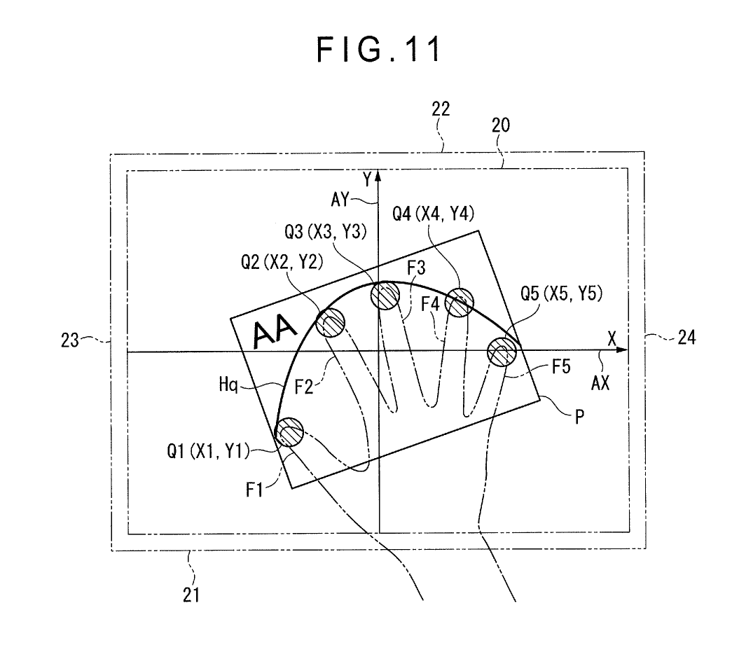

Subsequently, the estimating unit 44A of the controller 4A approximates the pointed positions of the fingers F to a curve that passes through all the pointed positions as shown in FIG. 11, the curve being a quadratic curve Hq represented by the following equation (1), (step S21), and determines whether or not A in the equation (1) is a negative value (step S22).

Y=AX²+BX+C (1)

X: X-coordinate value

Y: Y-coordinate value

A, B, C: constant value

When the estimating unit 44A determines that A is negative in step S22, the controller 4A performs the processes of steps S12 and S13.

Specifically, in the case as shown in FIG. 11, since the value of A is negative, the controller 4A estimates that an operator is present near the front portion 21 relative to the display surface 20 and redisplays the object image P in the proper orientation relative to the front portion 21 as shown in FIG. 8.

In contrast, when the estimating unit 44A determines that the value of A is positive in step S22, the controller 4A performs the processes of steps S14 and S15.

### Effects of Second Exemplary Embodiment

The above second exemplary embodiment provides the following effect (3) in addition to the same effect as the effect (1) of the first exemplary embodiment.

(3) The touch panel device 1A defines the two-dimensional coordinate plane and approximates the fingers F to the curve that passes through all the fingers F, the curve being the quadratic curve Hq represented by the equation (1). The touch panel device 1A estimates that an operator is present on the negative direction side with reference to the Y-axis AY (i.e., near the front portion 21) when the value of A in the equation (1) is negative or estimates that the operator is present on the positive direction side with reference to the Y-axis AY (i.e., near the rear portion 22) when the value is positive.

With this arrangement, the touch panel device 1A can estimate the position where the operator is present in such a simple manner as calculation based on the coordinates of the pointed positions specified in the coordinate plane.

### Modification(s)

It should be appreciated that the scope of the invention is not limited to the above first and second exemplary embodiments but modifications, improvements and the like that are compatible with an object of the invention are included within the scope of the invention.

Specifically, in the first exemplary embodiment, the controller 4 may determine that an operator is present on the side opposite, across the reference line Hs, to a side where the rest of the pointed positions of the fingers F, which are not used to define the reference line Hs, exist. For instance, in the case as shown in FIG. 6, the controller 4 may determine that an operator is present on the side opposite, across the reference line Hs, to a side where the pointed position Q2 of the index finger F2 exists without defining the coordinate plane.

In the first or second exemplary embodiment, when an operator near the front portion 21 wishes to properly show the object image P to another operator near the rear portion 22, the controller 4 or 4A may redisplay the object image P in the proper orientation relative to the rear portion 22 even when it is determined that the operator is present near the front portion 21.

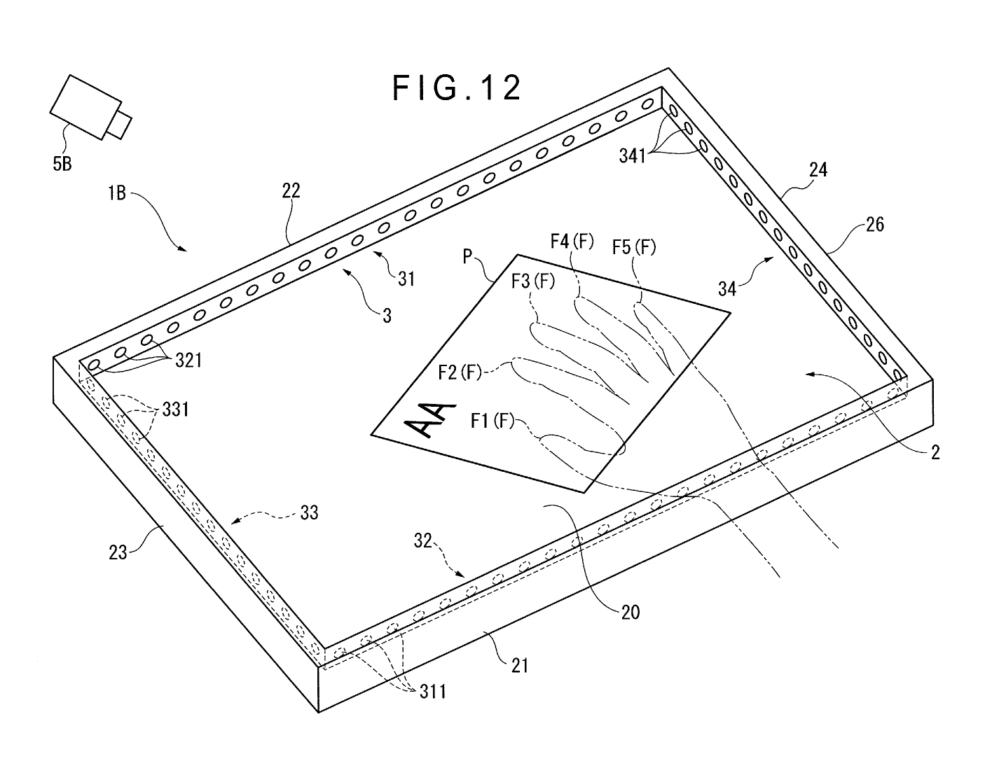

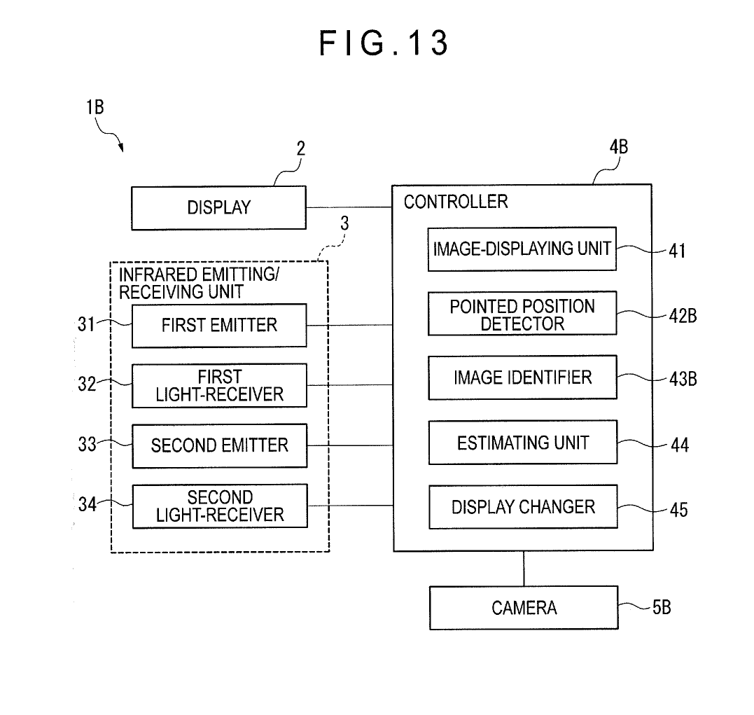

A touch panel device 1B as shown in FIGS. 12 and 13 may alternatively be used.

Unlike the touch panel device 1 according to the first exemplary embodiment, the touch panel device 1B includes: a camera 5B capable of capturing an entire image of the display surface 20. Further, a controller 4B of the touch panel device 1B includes a pointed position detector 42B and an image identifier 43B that perform processes different from ones described above.

Specifically, upon determination that the display surface 20 is double-tapped with three or more of the fingers F through light-interception scanning, the pointed position detector 42B of the controller 4B controls the camera 5B to capture an image of the display surface 20 instead of detecting the pointed positions of the fingers F based on the light-intercepted state. The pointed position detector 42B then detects the pointed positions based on the positions of the fingers F shown in the captured image.

The image identifier 43B determines whether or not the same object image P is touched with the three or more fingers F based on the captured image.

Instead of detecting such a motion of the fingers F that the same object image P is intermittently touched twice with three of the fingers F (i.e., so-called double-tapping), the pointed position detector 42 may detect that the object image P is touched three or four times or more or may detect the motion of three or four of the fingers F. Alternatively, the pointed position detector 42 may detect such a motion that the same object image P is continuously touched for a predetermined duration of time or longer with three or more of the fingers F (i.e., the same object image P is kept touched).

In step S5, it is exemplarily determined whether or not the same object image P is touched successively twice with all of the three or more fingers F. Such an arrangement, however, may be replaced with the following arrangement.

Specifically, it may be determined whether or not the same object image P gets overlapped successively twice with at least part of an area R surrounded by all the three or more fingers F (i.e., an area bounded by a line that passes through the pointed positions Q1 to Q5 as shown by a chain line in FIG. 6). In this case, when the same object image P gets overlapped successively twice with at least part of the area R, the process of step S6 is performed, or when the same object image P does not get overlapped, the process returns to step S2.

Alternatively, it may be determined whether or not the same object image P gets overlapped successively twice with a center position or an average position of the area R.

A position where an operator is present may be detected using electrostatic capacity, electromagnetic induction or the like. Alternatively, a data communication via Bluetooth (trademark) may be used.

For instance, the pointer may be, for instance, a dedicated pen member including three or more stick-shaped pointing units in place of the fingers F.

The touch panel device 1 may be used as a display for a portable or fixed computer, PDA (Personal Digital Assistant), mobile phone, camera, clock or content player, or may be wall-mountable. Further, the touch panel device 1 may be used to display information for business use or in-car information, or may be used to operate an electronic device.

### EXPLANATION OF CODE(S)

1, 1A, 1B . . . touch panel device
2 . . . display
P . . . object image
F . . . finger (pointer)
20 . . . display surface
41 . . . image-displaying unit
42, 42B . . . pointed position detector
43, 43B . . . image identifier
44, 44A . . . estimating unit
45 . . . display changer
Hs . . . reference line
Hq . . . quadratic curve

1. An information processing method for a touch panel device that performs a process in accordance with a position of a pointer brought into contact or almost into contact with a display surface of the touch panel device that is disposed to face upward, the method comprising:
displaying an object image on the display surface;
detecting, when an operator brings the pointer comprising three or more pointers into contact or almost into contact with the display surface, respective pointed positions corresponding to the three or more pointers;
identifying the object image that is displayed in at least part of an area surrounded by the pointed positions of the three or more pointers;
estimating a position where the operator, who has the three or more pointers, is present based on a position relationship of the pointed positions of the three or more pointers; and
changing a display state of the identified object image such that the identified object image is set in a predetermined orientation in accordance with the estimated position of the operator, wherein
in the detecting of the representative pointed positions, the pointed positions are detected using any one of infrared radiation, electrostatic capacity and electromagnetic induction, and
the estimating of the position where the operator is present comprises:
defining a reference line that linearly connects furthest two of the pointed positions; and
estimating that the operator is present on a side opposite, across the reference line, to a side where the pointed positions other than the two pointed positions exist.

2. (canceled)

3. The information processing method for the touch panel device according to claim 1, wherein the estimating of the position where the operator is present comprises:
defining a two-dimensional coordinate plane comprising mutually intersecting first coordinate axis and second coordinate axis in the display surface;
calculating lengths of perpendicular lines from the pointed positions other than the two pointed positions to the reference line;
determining that: the lengths of the perpendicular lines are positive when the pointed positions other than the two pointed positions, which are located at first ends of the perpendicular lines, are larger in a second coordinate value plotted on the second coordinate axis than second ends of the perpendicular lines on the reference line; or the lengths of the perpendicular lines are negative when the pointed positions other than the two pointed positions are smaller in the second coordinate value;
summing up the lengths from the pointed positions other than the two pointed positions after the lengths are determined to be positive or negative; and
estimating that: the operator is present on a negative direction side with reference to the second coordinate axis when a sum value of the lengths is a positive value; or the operator is present on a positive direction side with reference to the second coordinate axis when the sum value of the lengths is a negative value.

4. An information processing method for a touch panel device that performs a process in accordance with a position of a pointer brought into contact or almost into contact with a display surface of the touch panel device that is disposed to face upward, the method comprising:
displaying an object image on the display surface;
detecting, when an operator brings the pointer comprising three or more pointers into contact or almost into contact with the display surface, respective pointed positions corresponding to the three or more pointers;
identifying the object image that is displayed in at least part of an area surrounded by the pointed positions of the three or more pointers;
estimating a position where the operator, who has the three or more pointers, is present based on a position relationship of the pointed positions of the three or more pointers; and
changing a display state of the identified object image such that the identified object image is set in a predetermined orientation in accordance with the estimated position of the operator, wherein
in the detecting of the respective pointed positions, the pointed positions are detected using any one of infrared radiation, electrostatic capacity and electromagnetic induction, and
the estimating of the position where the operator is present comprises:
defining a two-dimensional coordinate plane comprising mutually intersecting first coordinate axis and second coordinate axis in the display surface;
approximating the pointed positions to a curve that passes through all the pointed positions, the curve being represented by an equation (1) below,
Y=AX²+BX+C (1)
where:
X represents a first coordinate value plotted on the first coordinate axis;
Y represents a second coordinate value plotted on the second coordinate axis; and
A, B and C each represent a constant value; and
estimating that: the operator is present on a positive direction side with reference to the second coordinate axis when A in the equation (1) is a positive value; or the operator is present on a negative direction side with reference to the second coordinate axis when A is a negative value.

5. A touch panel device that performs a process in accordance with a position of a pointer brought into contact or almost into contact with a display surface of the touch panel device, the touch panel device comprising:
a display comprising the display surface disposed to face upward;
an image-displaying unit being configured to display an object image on the display surface;
a pointed position detector being configured to detect, when an operator brings the pointer comprising three or more pointers into contact or almost into contact with the display surface, respective pointed positions corresponding to the three or more pointers;
an image identifier being configured to identify the object image that is displayed in at least part of an area surrounded by the pointed positions of the three or more pointers;
an estimating unit being configured to estimate a position where the operator, who has the three or more pointers, is present based on a position relationship of the pointed positions of the three or more pointers; and
a display changer being configured to change a display state of the identified object image such that the identified object image is set in a predetermined orientation in accordance with the estimated position of the operator, wherein
the pointed position detector detects the pointed positions using any one of infrared radiation, electrostatic capacity and electromagnetic induction, and
the estimating unit defines a reference line that linearly connects furthest two of the pointed positions, and estimates that the operator is present on a side opposite, across the reference line, to a side where the pointed positions other than the two pointed positions exist.

6. (canceled)

7. The touch panel device according to claim 5, wherein the estimating unit:
defines a two-dimensional coordinate plane comprising mutually intersecting first coordinate axis and second coordinate axis in the display surface;
calculates lengths of perpendicular lines from the pointed positions other than the two pointed positions to the reference line;
determines that: the lengths of the perpendicular lines are positive when the pointed positions other than the two pointed positions, which are located at first ends of the perpendicular lines, are larger in a second coordinate value plotted on the second coordinate axis than second ends of the perpendicular lines on the reference line; or the lengths of the perpendicular lines are negative when the pointed positions other than the two pointed positions are smaller in the second coordinate value;
sums up the lengths from the pointed positions other than the two pointed positions after the lengths are determined to be positive or negative; and
estimates that: the operator is present on a negative direction side with reference to the second coordinate axis when a sum value of the lengths is a positive value; or the operator is present on a positive direction side with reference to the second coordinate axis when the sum value of the lengths is a negative value.

8. A touch panel device that performs a process in accordance with a position of a pointer brought into contact or almost into contact with a display surface of the touch panel device, the touch panel device comprising:
a display comprising the display surface disposed to face upward;
an image-displaying unit being configured to display an object image on the display surface;
a pointed position detector being configured to detect, when an operator brings the pointer comprising three or more pointers into contact or almost into contact with the display surface, respective pointed positions corresponding to the three or more pointers;
an image identifier being configured to identify the object image that is displayed in at least part of an area surrounded by the pointed positions of the three or more pointers;
an estimating unit being configured to estimate a position where the operator, who has the three or more pointers, is present based on a position relationship of the pointed positions of the three or more pointers; and
a display changer being configured to change a display state of the identified object image such that the identified object image is set in a predetermined orientation in accordance with the estimated position of the operator, wherein
the pointed position detector detects the pointed positions using any one of infrared radiation, electrostatic capacity and electromagnetic induction, and
the estimating unit:
defines a two-dimensional coordinate plane comprising mutually intersecting first coordinate axis and second coordinate axis in the display surface;
approximates the pointed positions to a curve that passes through all the pointed positions, the curve being represented by an equation (1) below,
Y=AX²+BX+C (1)
where:
X represents a first coordinate value plotted on the first coordinate axis;
Y represents a second coordinate value plotted on the second coordinate axis; and
A, B and C each represent a constant value; and
estimates that: the operator is present on a positive direction side with reference to the second coordinate axis when A in the equation (1) is a positive value; or the operator is present on a negative direction side with reference to the second coordinate axis when A is a negative value.
